(19) United States
(12) Patent Application Publication
(10) Pub. No.: US 2022/0237637 A1
(43) Pub. Date: Jul. 28, 2022

(54) SYSTEMS AND METHODS FOR REAL TIME CROWDSOURCING

(71) Applicant: Meta Platforms, Inc., Menlo Park, CA (US)

(72) Inventor: Tom Susel, London (GB)

(21) Appl. No.: 16/224,066

(22) Filed: Dec. 18, 2018

(51) Int. Cl. G06Q 30/02; H04L 12/58; G06Q 50/00

(52) U.S. Cl. CPC G06Q 30/0203; G06Q 50/01; H04L 51/32

(57) ABSTRACT

Systems, methods, and non-transitory computer-readable media can be configured to receive a question associated with an entity. At least one local user can be determined based at least in part on a location associated with the at least one local user. The question can be provided to the at least one local user.

### FIELD OF THE INVENTION

The present technology relates to the fields of networked communications. More particularly, the present technology relates to computerized networking techniques for connecting users for sharing information in real time.

### BACKGROUND

Today, people often utilize computing devices (or systems) for a wide variety of purposes. For example, users can use their computing devices to create content, share content, and view content. In some cases, users can utilize their computing devices to access a social network and post content to the social network. Content posted to the social network may include text content items and media content items, such as audio, images, and videos. The posted content may be published to the social network and be accessed, shared, or viewed by other users.

### SUMMARY

Various embodiments of the present technology can include systems, methods, and non-transitory computer readable media configured to receive a question associated with an entity. At least one local user can be determined based at least in part on a location associated with the at least one local user. The question can be provided to the at least one local user.

In some embodiments, the question is one of a set of suggested questions, and the set of suggested questions is ranked based at least in part on a frequency associated with each suggested question.

In some embodiments, the question associated with the entity can be determined to be inappropriate, inapplicable, or improperly formatted. The question associated with the entity can be filtered.

In some embodiments, the at least one local user has been located at the entity within a threshold amount of time.

In some embodiments, at least one answer can be received from the at least one local user. The at least one answer can be provided to a user from whom the question associated with the entity was received.

In some embodiments, the location associated with the at least one local user can be confirmed based at least in part on the at least one answer.

In some embodiments, the at least one local user is included in a plurality of local users. A plurality of answers can be received from the plurality of local users. A consensus response can be determined based at least in part on the plurality of answers. The consensus response can be provided to a user from whom the question associated with the entity was received.

In some embodiments, determining the consensus response based at least in part on the plurality of answers occurs after a threshold amount of time.

In some embodiments, a feature or a trend associated with the entity can be extrapolated based at least in part on the question and the plurality of answers.

In some embodiments, another question associated with the entity can be received. An answer to the other question can be provided based at least in part on the feature or trend associated with the entity.

It should be appreciated that many other features, applications, embodiments, and/or variations of the present technology will be apparent from the accompanying drawings and from the following detailed description. Additional and/or alternative implementations of the structures, systems, non-transitory computer readable media, and methods described herein can be employed without departing from the principles of the present technology.

### BRIEF DESCRIPTION OF THE DRAWINGS

FIG. 1 illustrates an example system including an example crowdsourcing information module, according to an embodiment of the present technology.

FIG. 2A illustrates an example of a local questions module, according to an embodiment of the present technology.

FIG. 2B illustrates an example of a local answers module, according to an embodiment of the present technology.

FIG. 3 illustrates an example of an extrapolation module, according to an embodiment of the present technology.

FIG. 4A-4C illustrate example interfaces, according to an embodiment of the present technology.

FIG. 5 illustrates an example process for providing a question to at least one local user, according to an embodiment of the present technology.

FIG. 6 illustrates a network diagram of an example system including an example social networking system that can be utilized in various scenarios, according to an embodiment of the present technology.

FIG. 7 illustrates an example of a computer system or computing device that can be utilized in various scenarios, according to an embodiment of the present technology.

The figures depict various embodiments of the present technology for purposes of illustration only, wherein the figures use like reference numerals to identify like elements. One skilled in the art will readily recognize from the following discussion that alternative embodiments of the structures and methods illustrated in the figures can be employed without departing from the principles of the present technology described herein.

### DETAILED DESCRIPTION

### Approaches for Real Time Crowdsourcing

Today, people often utilize computing devices (or systems) for a wide variety of purposes. For example, users can use their computing devices to create content, share content, and view content. In some cases, users can utilize their computing devices to access a social network and post content to the social network. Content posted to the social network may include text content items and media content items, such as audio, images, and videos. The posted content may be published to the social network and be accessed, shared, or viewed by other users.

Under conventional approaches, a user can navigate to various pages accessible through a social network (or social networking system). Some of these pages can be associated with various entities (e.g., businesses, restaurants, venues, places, locations, landmarks, etc.) and provide general information related to the various entities. As the user navigates these pages, the user may have questions about a particular entity. In some cases, information provided on a page associated with the particular entity may not provide sufficient information for answering the questions. Further, the questions may be time sensitive, and the user may desire prompt answers to the questions. In such cases, if the social network could provide sufficient information or provide prompt answers, then the social network could provide the user with valuable information in a timely manner and enhance the overall user experience. However, under conventional approaches, the ability of an entity to provide answers to certain questions concerning the entity and provide prompt answers to questions that are time sensitive remains elusive. Further, in some cases, only certain users, and not necessarily the entity itself, may have the information to provide such answers. Accordingly, conventional approaches can be ineffective for providing answers to questions concerning particular entities or prompt answers to questions that are time-sensitive. Thus, such conventional approaches are not effective in addressing these and other problems arising in computer technology.

An improved approach rooted in computer technology overcomes the foregoing and other disadvantages associated with conventional approaches specifically arising in the realm of computer technology. In various embodiments, the present technology can determine one or more local users who can provide answers to a question posed by a user on a communication platform, such as a social networking system. The answers can be generated from the local users in a crowdsourcing manner. The local users may constitute peers of the user. In general, local users can be other users who are capable of providing answers to questions concerning a particular entity (e.g., business, restaurant, venue, place, location, landmark, etc.) or to questions that are time sensitive. These local users can be determined based on various factors associated with, for example, their geographical location, location history, or social network information. The present technology can provide these local users with the question posed by the user. The present technology can acquire answers from the local users, determine a consensus response among the answers, and provide the user with the consensus response. For example, a user may be interested in visiting a venue and may want to know if there are people currently dancing there. The user may pose a question to a page associated with the venue. Local users who are currently at the venue, who were recently at the venue, or who are otherwise familiar with the venue can be notified of the question. A consensus response can be determined from the answers the local users provide, and the user can be notified of the consensus response in real time (or near real time). In some embodiments, the present technology can extrapolate information from questions and their corresponding answers. Such extrapolated information can indicate new or updated characteristics associated with an entity or trends associated with the entity. Continuing the above example, a number of users may pose questions, at various times, wanting to know if there are people currently dancing at the venue. Based on the corresponding answers, the present technology may extrapolate that, for example, people usually are dancing at the venue on Thursday nights and Friday nights. This information can be utilized to inform other users who are interested in when people are dancing at the venue. Accordingly, the present technology can provide prompt answers to questions concerning particular entities or time sensitive questions and, thus, provide valuable information to users in a timely manner and improve overall user experience on the communication platform. Additional details relating to the present technology are provided below.

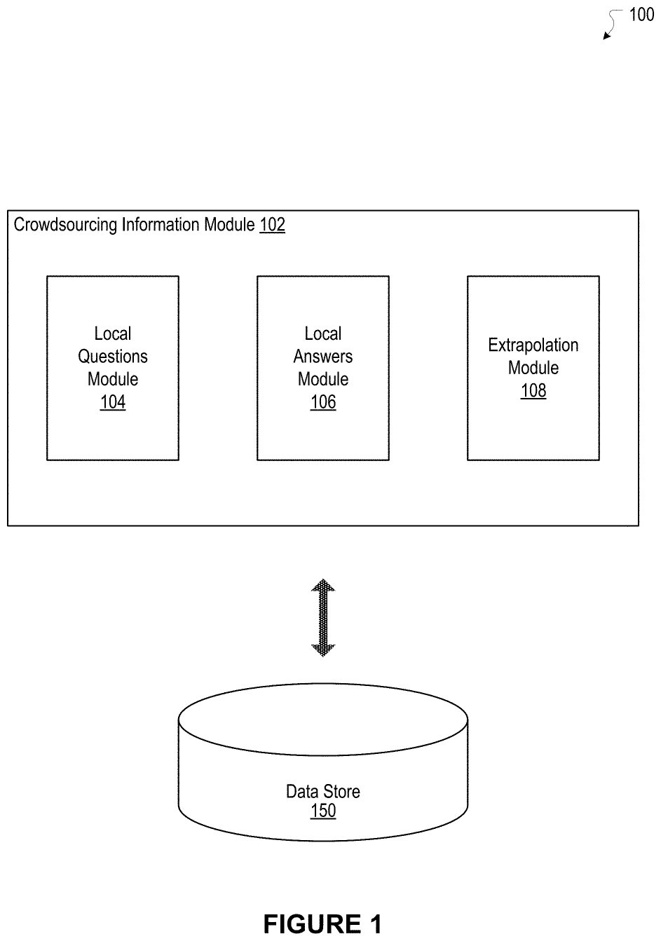

FIG. 1 illustrates an example system 100 including an example crowdsourcing information module 102, according to an embodiment of the present technology. The crowdsourcing information module 102 can be implemented on any communication or content platform or service, such as a social networking system, messaging service, news feed, customer assistance service, or any other type of information service. As shown in the example of FIG. 1, the crowdsourcing information module 102 can include a local questions module 104, a local answers module 106, and an extrapolation module 108. In some embodiments, the example system 100 can include at least one data store 150. The components (e.g., modules, elements, etc.) shown in this figure and all figures herein are exemplary only, and other implementations may include additional, fewer, integrated, or different components. Some components may not be shown so as not to obscure relevant details.

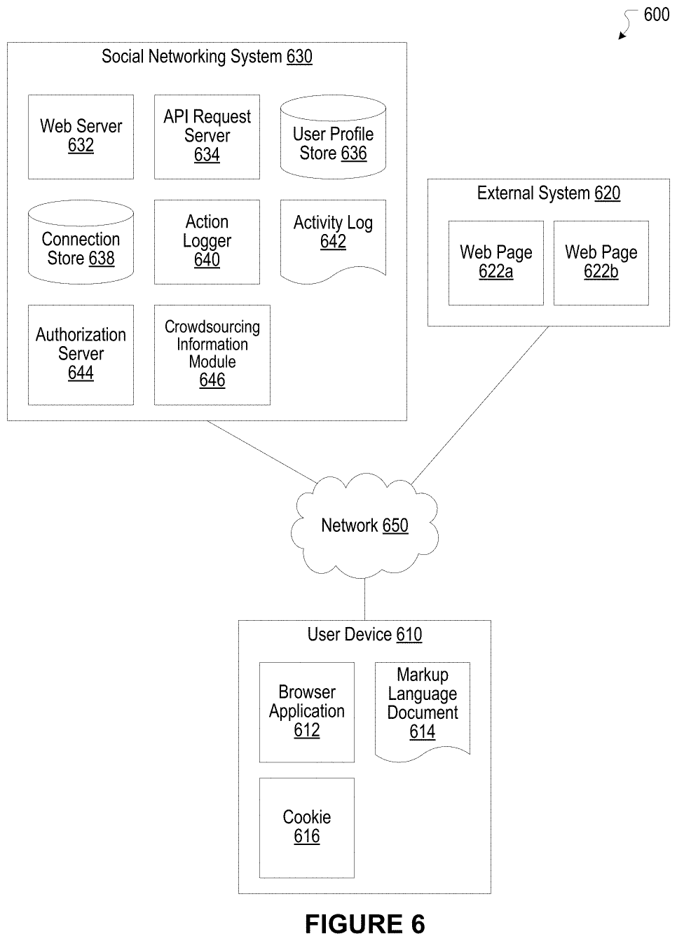

In some embodiments, the crowdsourcing information module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some embodiments, the crowdsourcing information module 102 can be implemented, in part or in whole, as software running on one or more computing devices or systems, such as on a user or client computing device. In one example, the crowdsourcing information module 102, or at least a portion thereof, can be implemented as or within an application (e.g., app), a program, or an applet, etc., running on a user computing device or a client computing system, such as the user device 610 of FIG. 6. In another example, the crowdsourcing information module 102 or at least a portion thereof can be implemented using one or more computing devices or systems that include one or more servers, such as network servers or cloud servers. In some embodiments, the crowdsourcing information module 102 can, in part or in whole, be implemented within or configured to operate in conjunction with a social networking system (or service), such as the social networking system 630 of FIG. 6.

The crowdsourcing information module 102 can be configured to communicate and/or operate with the at least one data store 150, as shown in the example system 100. The at least one data store 150 can be configured to store and maintain various types of data including, for example, questions posed by users, corresponding answers by local users, and extrapolated information based on the questions and answers. In some implementations, the at least one data store 150 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 150 can store information associated with users, such as user identifiers, user information, profile information, user specified settings, content produced or posted by users, and various other types of user data.

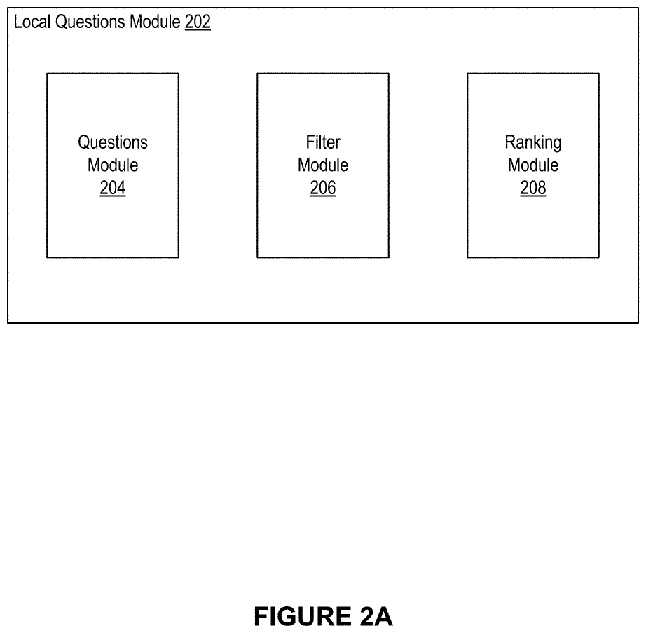

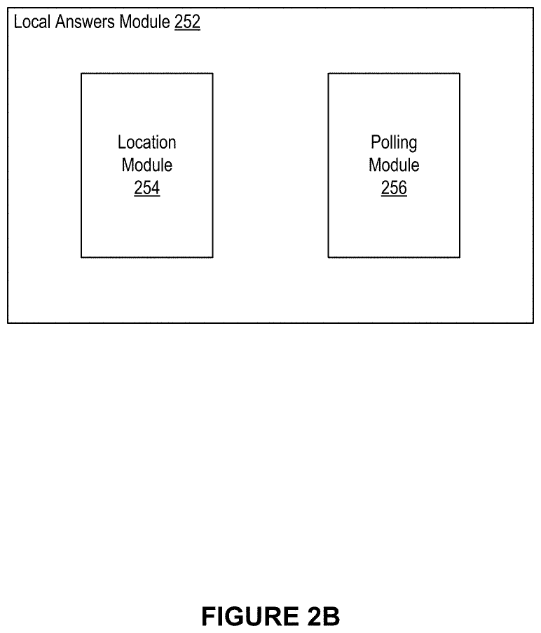

In various embodiments, the local questions module 104 allows users to pose questions concerning various entities (e.g., businesses, restaurants, venues, places, locations, landmarks, etc.). The local questions module 104 can allow users to pose questions through a user interface provided through a computing device. In some embodiments, users can pose questions through interactive elements on a page of a social networking system. A page can be associated with an entity and provide information about the entity in the social networking system. Users can utilize these interactive elements to provide text input or select from a list of suggested questions. The list of suggested questions can comprise questions that each user has frequently posed or questions that users have frequently posed to the entity. The local questions module 104 can compile the questions and rank the questions based on various factors to generate the list of suggested questions. In some embodiments, the local questions module 104 can filter posed questions to remove inappropriate, inapplicable, or improperly formatted questions. After a user poses a question, the local questions module 104 can notify the user when a consensus response has been determined for the question. More details regarding the local questions module 104 will be provided below with reference to FIG. 2A.

In various embodiments, the local answers module 106 can determine local users who can provide answers to a question posed by a user. In general, local users comprise other users who, based on various factors, are likely to have knowledge relevant to the question. These factors can include, for example, geographical location, location history, or social network information. These local users can constitute peers of the user who posed the question. In various embodiments, the local answers module 106 can notify and prompt local users to provide answers to the question and determine a consensus response among the provided answers. In some embodiments, a consensus response is determined by generating a poll and notifying local users to provide answers through the poll. More details regarding the local answers module 106 will be provided below with reference to FIG. 2B.

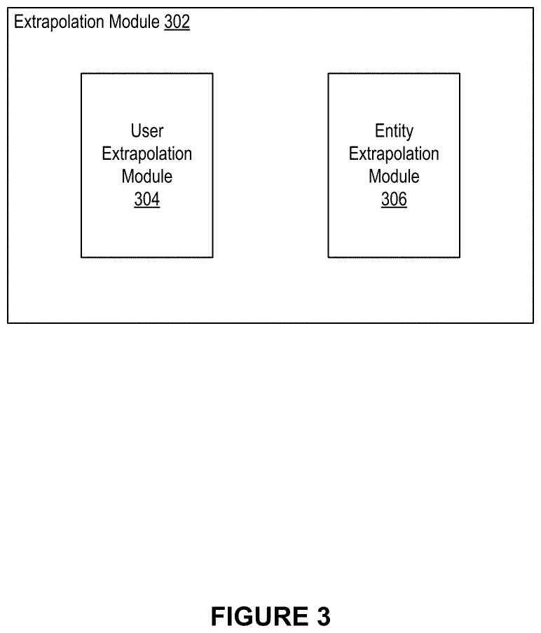

In various embodiments, the extrapolation module 108 can extrapolate information about users, local users, and entities based in part on questions posed by the users and answers provided by the local users. With regard to users and local users, the extrapolation module 108 can extrapolate various attributes associated with the users and local users. These attributes can describe preferences or tendencies that the users and local users may have. Further, geographical location information associated with local users can be confirmed with answers the local users provide. With regard to entities, the extrapolation module 108 can extrapolate various information associated with the entities. In general, this information can describe various features or trends that are not readily available, for example, on pages associated with the entities. For example, this information can include new or updated features, current or periodic trends, or various granular details. More details regarding the extrapolation module 108 will be provided below with reference to FIG. 3.

FIG. 2A illustrates an example of a local questions module 202 configured to provide an interface that allows users to pose questions concerning an entity, according to an embodiment of the present technology. Additionally, the local questions module 202 can also filter the questions and notify users when a consensus response has been determined. In some embodiments, the local questions module 104 of FIG. 1 can be implemented as the local questions module 202. As shown in FIG. 2A, the local questions module 202 can include a questions module 204, a filter module 206, and a ranking module 208.

The questions module 204 can provide an interface through which users can pose questions directed to an entity. The interface can be utilized, for example, through the users' computing devices. In some embodiments, the interface can be a part of or related to a page associated with the entity. The page can be provided through a social networking system. In some embodiments, the interface may not be associated with an entity, and the entity to which a question is directed is determined based on language in the question. The questions module 204 can allow users to pose questions through text input or through selection from a list of suggested questions. In some embodiments, the questions module 204 may allow users, local users, and entities to choose to opt-out or opt-in to utilize the present technology. Users who opt-in to pose questions may be encouraged or required to opt-in to providing answers as local users as well. In some embodiments, the questions module 204 can indicate a number of local users, who may have chosen to opt-in, available to answer a question. Users and local users may opt-in to various location based services to utilize the present technology. Further, users and local users may choose to pose questions or provide answers anonymously. Entities may opt-in to allow users to pose questions on pages associated with the entities. Many variations are possible.

The filter module 206 can determine whether questions posed by users are improper and, accordingly, filter the improper questions. In general, filtering improper questions prevents undesirable questions from being distributed to other users. The filter module 206 can determine whether questions are improper based on various factors associated with the content or format of the questions. For example, improper questions can include inappropriate, inapplicable, or improperly formatted questions. Inappropriate questions can include, for example, questions about inappropriate (e.g., offensive, racist, violent, illegal, etc.) topics or language. Inapplicable questions can include, for example, questions that are irrelevant to an entity to which the questions are directed. Improperly formatted questions can include, for example, statements phrased as questions or rhetorical questions. The filter module 206 can apply one or more machine learning or language processing techniques that can identify and filter inappropriate, inapplicable, or improperly formatted questions. For example, if a user poses a question phrased with offensive language, then the filter module 206 can determine that offensive language is being used in the question. The question can be filtered and prevented from being provided to other users. As another example, a user may pose a question directed to a restaurant asking something irrelevant, such as whether the sky is blue. The filter module 206 can determine that the subject of the question is inapplicable or irrelevant to an entity to which the question is directed (i.e., the restaurant) and, accordingly, filter the question. As an additional example, a user may state criticism of a restaurant phrased as a question (e.g., Isn't this restaurant the worst?) The filter module 206 can determine that the question is improperly formatted as a statement phrased as a question or rhetorical question and, accordingly, filter the question. Many variations are possible.

In some embodiments, the filter module 206 can apply one or more rule-based filters. In some cases, one or more rule-based filters can be established for a specific entity. The rule-based filters can be established by a user associated with the specific entity, such as a user managing a page associated with the specific entity (e.g., admin). The rule-based filters can keep certain information associated with a specific entity private, secret, or otherwise undisclosed. For example, a restaurant may have secret menu specials and want to prevent users from knowing what the secret menu specials are without visiting the restaurant. In this example, a filter can be established to prevent questions asking about the secret menu specials. In some embodiments, questions can be restricted to certain formats. In some cases, restricting questions to certain formats may facilitate answers from which a consensus response is more readily determined. For example, questions can be restricted to those that elicit a limited number of possible answers. Such questions can include binary questions or questions that can be answered affirmatively or negatively (e.g., yes or no questions). The filter module 206 can filter questions that do not satisfy certain formats. For example, an open-ended question, such as, “What does this place have for kids?” can be filtered, whereas a closed-ended question, such as, “Does this place have crayons for kids?” can be allowed. In this example, the closed-ended question is more likely to induce answers (e.g., yes or no) from which a consensus response can be determined. Accordingly, filtering questions through one or more of the techniques described herein can boost the efficacy and usefulness of questions posed by users.

The ranking module 208 can compile and rank a list of suggested questions from which a user can select a question to pose. The ranking module 208 can compile a list of suggested questions that are relevant to a user posing a question or to an entity to which the question is directed. Such questions can comprise frequent or common questions posed by the user, directed to the entity, or directed to other entities similar to the entity. The ranking module 208 can rank a list of suggested questions based on various factors. For example, the various factors can be associated with a user selecting a question or an entity associated with the list of suggested questions. In some embodiments, a list of suggested questions can be ranked based on which questions correspond to questions that a user frequently (e.g., a frequency that satisfies a threshold frequency value) poses. Suggested questions that correspond to questions that a user frequently poses can be ranked higher than questions that the user seldom poses. In some embodiments, a list of suggested questions can be ranked based in part on a frequency with which each suggested question is posed by users to an entity, or to other entities similar to the entity. Questions that are more frequently posed to the entity, or to the other entities, can be ranked higher than questions that are less frequently posed to the entity, or the other entities. In some embodiments, the ranking can be based in part on other factors such as time and date information. Questions that are more frequently posed at a certain time or day may be ranked higher at the certain time or day. Many variations are possible.

In some embodiments, a list of suggested questions can comprise frequently or commonly (e.g., a frequency that satisfies a threshold frequency value) posed questions to which an answer is readily available. A readily available answer may be based on information extrapolated from previously posed questions and their corresponding answers. For example, users may frequently pose questions directed to a restaurant asking whether the restaurant has a children's menu. Based on corresponding answers, it may be extrapolated, as discussed in more detail herein, that the restaurant does have a children's menu. Accordingly, whether the restaurant has a children's menu can be included in a list of suggested questions for the restaurant. In some cases, ranking a list of suggested questions can be based on whether an answer is readily available. Questions to which an answer can be provided based on extrapolated information may be ranked higher than questions to which an answer can be provided by local users. Ranking a list of suggested questions through one or more of the techniques described herein can assist a user with efficiently selecting relevant questions to pose.

FIG. 2B illustrates an example of a local answers module 252 configured to determine local users who can provide answers to a question posed by a user and, accordingly, acquire answers from the local users. The determination and acquisition of this information can constitute crowdsourcing information related to the question. In some embodiments, the local answers module 106 of FIG. 1 can be implemented as the local answers module 252. As shown in FIG. 2B, the local answers module 252 can include a location module 254 and a polling module 256.

The location module 254 can determine local users to potentially answer questions posed by users. The determination can be based on, for example, geographical location or location history associated with users. In general, users who are most likely to be able to provide an answer to a question directed to an entity are users who currently are or recently were located at the entity. Local users can be determined from these users. In some embodiments, local users can be determined based on a set of users who are or were located at the premises of an entity within a threshold period of time. The threshold period of time can be associated with a time sensitivity or specificity of a question. Questions directed to information that is less likely to change can be associated with a longer threshold period of time, and questions directed to information that is more likely to change quickly can be associated with a shorter threshold period of time. For example, a question asking whether a restaurant has high-chairs available for children is directed to information that is unlikely to change quickly. Accordingly, local users for this question can comprise users who have been to the restaurant within a relatively longer threshold period of time (e.g., 1 day). In contrast, a question asking whether the restaurant has an open table available is directed to information that is likely to change quickly. Accordingly, local users for this question can comprise users who have been to the restaurant within a relatively shorter threshold period of time (e.g., 30 minutes). In some embodiments, the location module 254 can determine geographical location or location history associated with users based on social network information. User interactions with a social networking system (e.g., posting a comment, posting a review, sharing a page, etc.) can indicate associations, interactions, and visits with various locations. For example, a user who posts a review for a restaurant is likely to have recently visited the restaurant. As another example, a user may have activated a check-in feature indicating the time and location of the user when, for example, paying a visit to a premises of an entity. Based on the user's social network information, it can be determined that the user may be a potential local user for a question directed to the restaurant.

The polling module 256 can notify local users that a question has been posed and acquire corresponding answers from the local users. The polling module 256 can generate a notification or a message to direct a local user to a page associated with an entity to which a question is directed. The question can be provided on the page associated with the entity. Local users can provide answers to the question through the page. In some embodiments, local users can provide answers through text input or through multiple choice selection. In some embodiments, local users can provide an answer indicating that they do not know the answer. For example, when a yes or no question has been posed, local users can be provided with a multiple choice selection with three choices: “Yes,” “No,” and “Don't Know.” In some embodiments, the polling module 256 can provide questions to local users as polls and local users can provide answers by inputting their votes. Upon inputting their votes, the polling module 256 can provide local users with a tally of votes and an indication of how they voted. In some embodiments, local users can retract their answers or votes subsequent to providing them. For example, a user may pose a question asking whether a restaurant has high-chairs for children. As the question is a yes or no question, a poll can be provided to local users with options to vote for “Yes,” “No,” or “Don't Know.” A local user may initially vote “Yes” but, after subsequent consideration, retract the vote and select “Don't Know.” Many variations are possible.

The polling module 256 can determine a consensus response among the answers provided. The polling module 256 can provide a consensus response that corresponds with an answer that a number of local users have provided with regard to a posed question. The consensus response can correspond with an answer that a majority of local users provide or an answer that the highest number of local users provide. In some embodiments, for questions are time sensitive, the polling module 256 may determine a consensus response after a threshold amount of time from when a question was posed or a threshold number of answers have been provided. For example, a user may pose a question asking whether a restaurant has an open table available, and the question can be provided to local users to answer. As the question suggests that it is time sensitive, a consensus response may be determined based on answers provided within a threshold amount of time (e.g., 30 minutes). After the threshold amount of time, the consensus response is provided to the user. In some embodiments, a threshold amount of time after which a consensus response is to be provided can be determined using machine learning techniques. For example, definitive answers (e.g., yes, no, etc.) and their timing can be instances of positive data and indefinite answers and their timing (e.g., don't know) can be instances of negative data. Such data can be used to train one or more machine learning models to determine an appropriate threshold amount of time with which to determine a consensus response to a question. Once trained, the one or more machine learning models can determine an appropriate threshold amount of time for a question. An appropriate threshold amount of time can be, for example, based on a minimum amount of time to acquire a maximum amount of definitive answers. In some embodiments, the polling module 256 can provide an answer to a question based on information extrapolated about an entity to which the question is directed. As described in more detail herein, various features or trends may be extrapolated about an entity based on questions directed to the entity and corresponding answers. Accordingly, the polling module 256 can utilize features or trends extrapolated about an entity to provide an answer to a question directed to the entity.

FIG. 3 illustrates an example of an extrapolation module 302 configured to determine or extrapolate information. The information can relate to various attributes associated with, for example, users, local users, entities, and locations. In some embodiments, the extrapolation module 108 of FIG. 1 can be implemented as the extrapolation module 302. As shown in FIG. 3, the extrapolation module 302 can include an user extrapolation module 304 and an entity extrapolation module 306.

The user extrapolation module 304 can extrapolate information about users and local users based in part on questions posed by the users and answers provided by the local users. In general, questions posed by users are suggestive of various preferences and tendencies the users may have. A user may pose similar questions at a threshold frequency. These similar questions may indicate a preference or tendency associated with the user. The user extrapolation module 304 can determine, based on questions posed by a user, preferences or tendencies associated with the user. For example, a user may frequently pose questions asking whether people are dancing at various venues. These frequently posed questions may indicate that the user has a preference for venues where people dance. Further information can be extrapolated about users based on user actions performed subsequent to posing questions. When a user performs an action subsequent to posing a question, there may be a correlation between the action and the question indicative of some characteristics associated with the user. In some embodiments, the user extrapolation module 304 can determine, based on questions posed by a user and user actions performed by the user, preferences and tendencies associated with the user. Continuing the above example, information associated with the user's geographical location may indicate that, subsequent to posing questions asking whether people are dancing at various venues, the user frequently visits places where people are dancing. This correlation between user action and question is further indicative of the user's preference for venues where people dance. Accordingly, the user extrapolation module 304 can determine that the user has a preference for venues where people dance. In some embodiments, the questions posed by users, user actions, and other related information, as described herein, can be used as training data for training machine learning models. Such machine learning models can be trained to extrapolate various preferences and tendencies associated with users. Many variations are possible.

In some embodiments, the user extrapolation module 304 can confirm location information associated with local users based in part on answers provided by the local users. In general, if multiple local users provide the same or similar answers in response to a question, then it may be indicative that the multiple local users have visited the entity to which the question is directed. In contrast, if a local user provides an answer dissimilar to those provided by other local users, then it may be indicative that the local user has not visited the entity to which the question is directed. For example, a number of local users can be provided with a yes or no question directed to a location. In this example, one local user may answer yes while the other local users answer no. The dissimilarity between the one local user's answer and the answers of the other local users suggests that the one local user has not been to the location.

The entity extrapolation module 306 can extrapolate information about entities based in part on questions directed to entities and corresponding answers. In general, users pose questions directed to entities about information that may not be readily available. An entity may have an associated page on a social networking system. The associated page may contain minimal information, or the associated page may be outdated. Based on questions directed to the entity and corresponding answers provided by local users, various information can be extrapolated about the entity. Such information can indicate features associated with the entity that are not available on the page associated with the entity. Further, such information may indicate various trends, schedules, or periods associated with the entity. For example, users may frequently pose questions directed to whether an entity has certain features. Based on the corresponding answers provided, it can be determined which features the entity has. For example, users may frequently pose questions asking whether a restaurant has air conditioning. Based on the answers provided, it can be determined whether the restaurant has air conditioning. As another example, users may frequently pose questions asking about events happening at an entity. Based on the corresponding answers provided, it can be determined whether the entity has periodic events and when those periodic events occur. For example, users may pose questions asking whether a venue is hosting a trivia night. Based on the corresponding answers provided, it can be determined whether the venue hosts a trivia night and when the trivia night occurs. As an additional example, questions and corresponding answers may indicate various trends related to an entity. For example, users may pose questions asking whether a restaurant has an open table available. Based on the answers provided, it can be determined what times the restaurant is busy and what times the restaurant is not busy. Many variations are possible.

In some embodiments, the entity extrapolation module 306 can associate various features with an entity based in part on extrapolated information about the entity. These various features can be searchable features associated with the entity. Users may search for features, and entities associated with the features may be provided as search results, even if the searched for features are not readily provided, for example, through pages associated with the respective entities. For example, based on a number of questions and corresponding answers, it may be determined that a certain restaurant has high chairs. Accordingly, a search for restaurants with high chairs would provide the certain restaurant as a search result. In some embodiments, the questions posed by users and related information, as described herein, can be used as training data for training machine learning models. Such machine learning models can be trained to determine various features or trends associated with entities. Accordingly, useful information about entities can be extrapolated from questions posed by users and corresponding answers provided by local users.

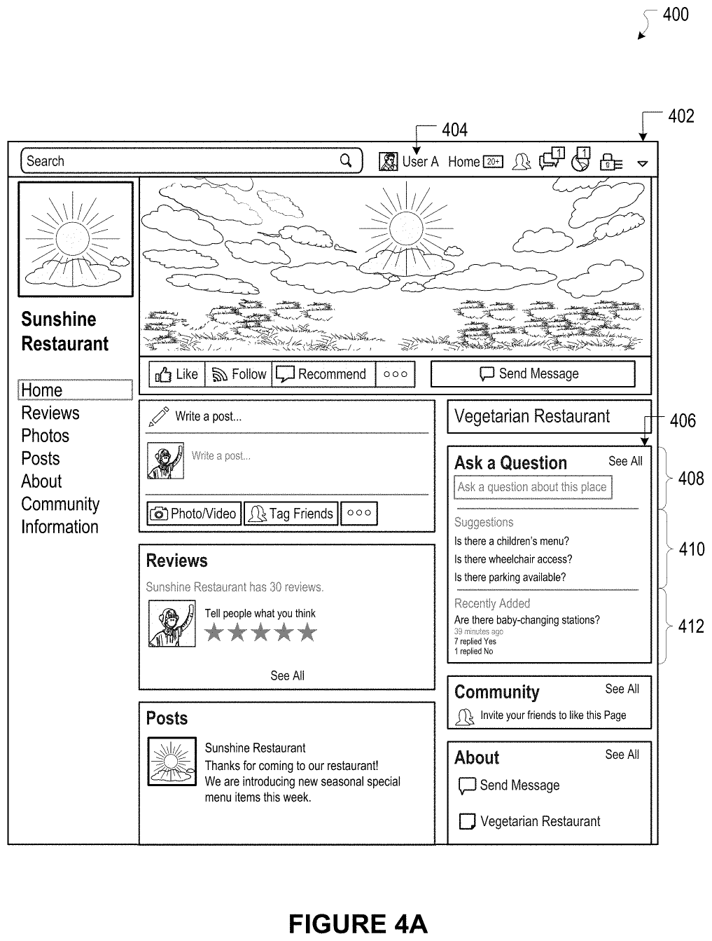

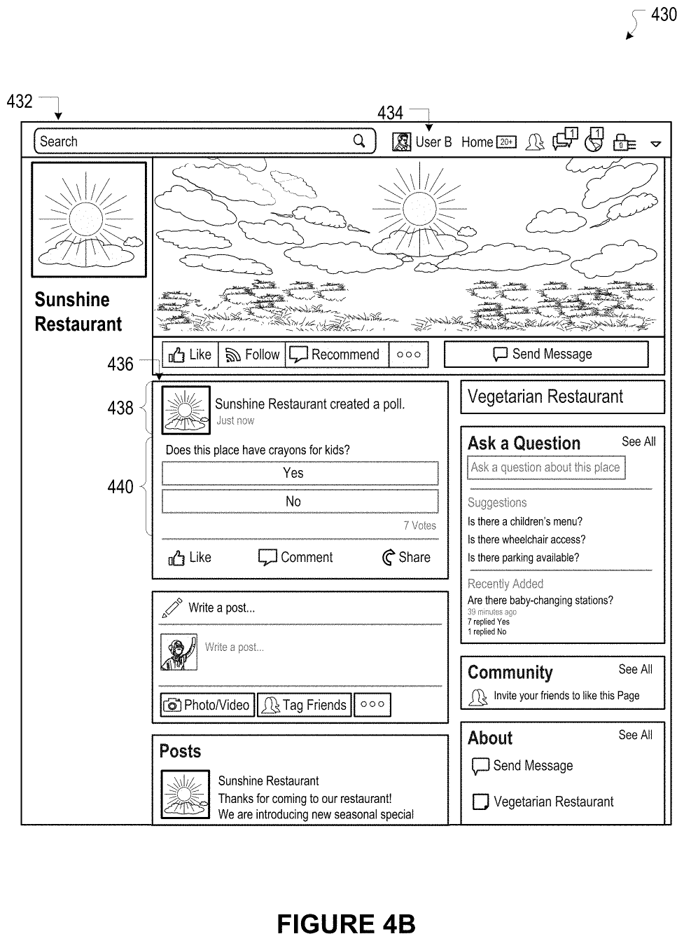

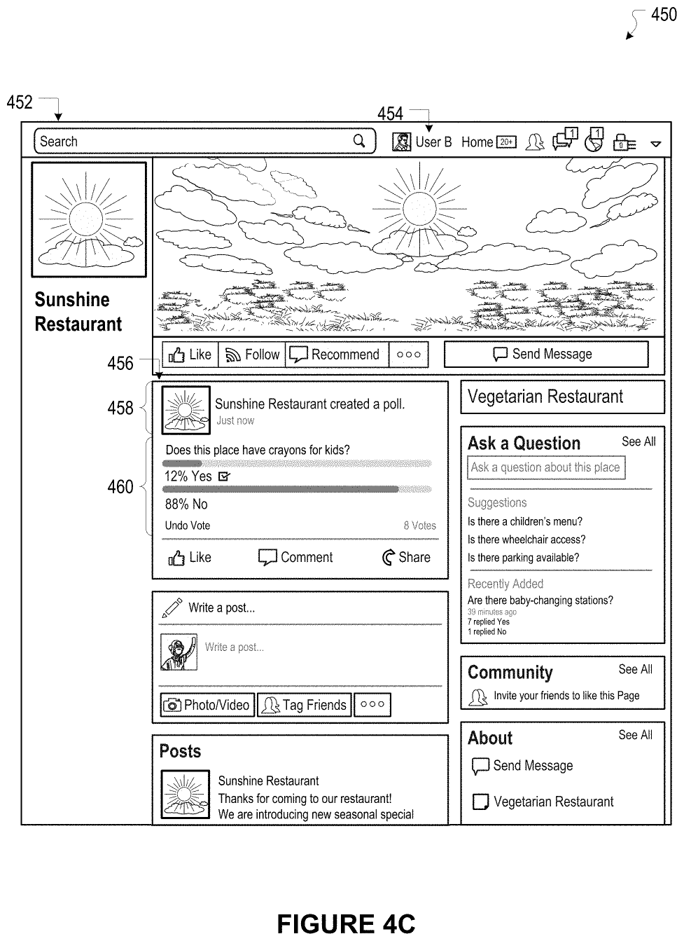

FIG. 4A illustrates an example interface 400 that is supported or implemented by the crowdsourcing information module 102, according to an embodiment of the present technology. The example interface 400 and other example interfaces provided herein may be presented through a display screen of a computing device. The example interface 400, and other example interfaces provided herein, may be provided through an application (e.g., a web browser, a social network application, a messaging application, etc.) running on the computing device. In this example, the example interface 400 displays a page 402 associated with an entity, Sunshine Restaurant. The page 402 is displayed for User A 404. In this example, User A 404 may be searching for a family friendly restaurant. User A 404 can pose a question directed to Sunshine Restaurant through an interactive section 406. The interactive section 406 comprises a question input section 408, a suggested questions section 410, and a recent questions section 412. The question input section 408 can allow User A 404 to pose a question directed to Sunshine Restaurant. The suggested questions section 410 can display a ranked list of suggested questions that users have frequently posed to the entity and can be ranked based on which questions are most frequently posed to the entity. In this example, the recent questions section 412 can display one or more recently posed questions directed to the entity, Sunshine Restaurant. The recent questions section 412 further displays the corresponding answers to the one or more recently posed questions. All examples herein are provided for illustrative purposes, and there can be many variations and other possibilities.

FIG. 4B illustrates an example interface 430 that is supported or implemented by the crowdsourcing information module 102, according to an embodiment of the present technology. In this example, the example interface 430 displays a page 432 associated with an entity, Sunshine Restaurant. The page 432 is displayed for User B 434. In this example, User B 434 can be a local user notified of a question, “Does this place have crayons for kids?” User B 434 can provide an answer to the question through an interactive section 436. The interactive section 436 comprises an entity section 438 and a polling section 440. The entity section 438 displays the entity, Sunshine Restaurant, to which the question is directed. The identity of the user who posed the question remains anonymous. The polling section 440 provides a multiple choice selection, yes or no, for providing an answer to the question. All examples herein are provided for illustrative purposes, and there can be many variations and other possibilities.

FIG. 4C illustrates an example interface 450 that is supported or implemented by the crowdsourcing information module 102, according to an embodiment of the present technology. In this example, the example interface 450 displays a page 452 associated with an entity, Sunshine Restaurant. The page 452 is displayed for User B 454. In this example, User B 454 can be a local user who just provided an answer to a question, “Does this place have crayons for kids?” User B 454 can view a current tally of provided answers through an interactive section 456. The interactive section 456 comprises an entity section 458 and a results section 460. The entity section 458 displays the entity, Sunshine Restaurant, to which the question is directed. The results section 460 provides the current tally of provided answers and a marker indicative of the answer User B 454 provided. The results section 460 also provides an option to retract the answer User B 454 provided. In some embodiments, a user who poses a question to an entity may be directed to a page associated with the entity that is similar to the page 452. The user may be provided with a consensus response to the question, similar to the interactive section 456 and the results section 460. In such embodiments, the results section 460 may not include a marker indicating an answer provided or an option to retract an answer. All examples herein are provided for illustrative purposes, and there can be many variations and other possibilities.

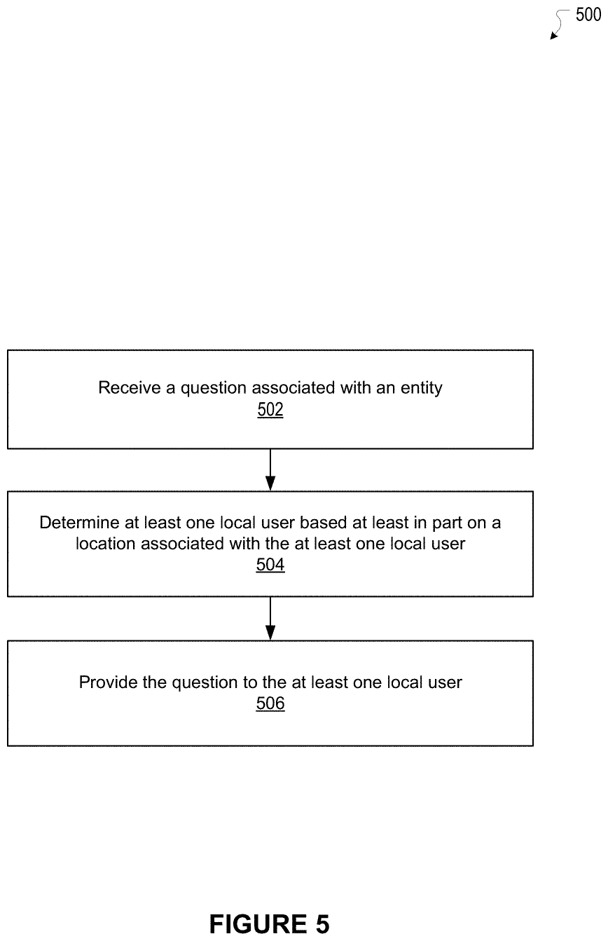

FIG. 5 illustrates an example method 500 for providing a question to at least one local user, according to an embodiment of the present technology. It should be understood that there can be additional, fewer, or alternative steps performed in similar or alternative orders, or in parallel, based on the various features and embodiments discussed herein unless otherwise stated.

At block 502, the example method 500 receives a question associated with an entity. The example method 500 can receive a question using one or more techniques as described above, such as with regard to local questions module 104 of FIG. 1. At block 504, the example method 500 determines at least one local user based at least in part on a location associated with the at least one local user. The example method 500 can determine the at least one local user using one or more techniques as described above, such as with regard to location module 254 of FIG. 2B. At block 506, the example method 500 provides the question to the at least one local user. The example method 500 can provide the question using one or more techniques as described above, such as with regard to polling module 256 of FIG. 2B

It is contemplated that there can be many other uses, applications, and/or variations associated with the various embodiments of the present technology. For example, in some cases, user can choose whether or not to opt-in to utilize the present technology. The present technology can also ensure that various privacy settings and preferences are maintained and can prevent private information from being divulged. In another example, various embodiments of the present technology can learn, improve, and/or be refined over time.

### Social Networking System—Example Implementation

FIG. 6 illustrates a network diagram of an example system 600 that can be utilized in various scenarios, in accordance with an embodiment of the present technology. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices (or systems) that can receive input from a user and transmit and receive data via the network 650. In one embodiment, the user device 610 is a computer system executing, for example, a Microsoft Windows compatible operating system (OS), macOS, and/or a Linux distribution. In another embodiment, the user device 610 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the Silverlight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content. As discussed previously, it should be appreciated that there can be many variations or other possibilities.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects another user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music, or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list.” External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a crowdsourcing information module 646. The crowdsourcing information module 646, for example, can be implemented as some or all of the functionality of the crowdsourcing information module 102 of FIG. 1. In some embodiments, some or all of the functionality of the crowdsourcing information module 646 can be implemented in the user device 610. As discussed previously, it should be appreciated that there can be many variations or other possibilities.

### Hardware Implementation

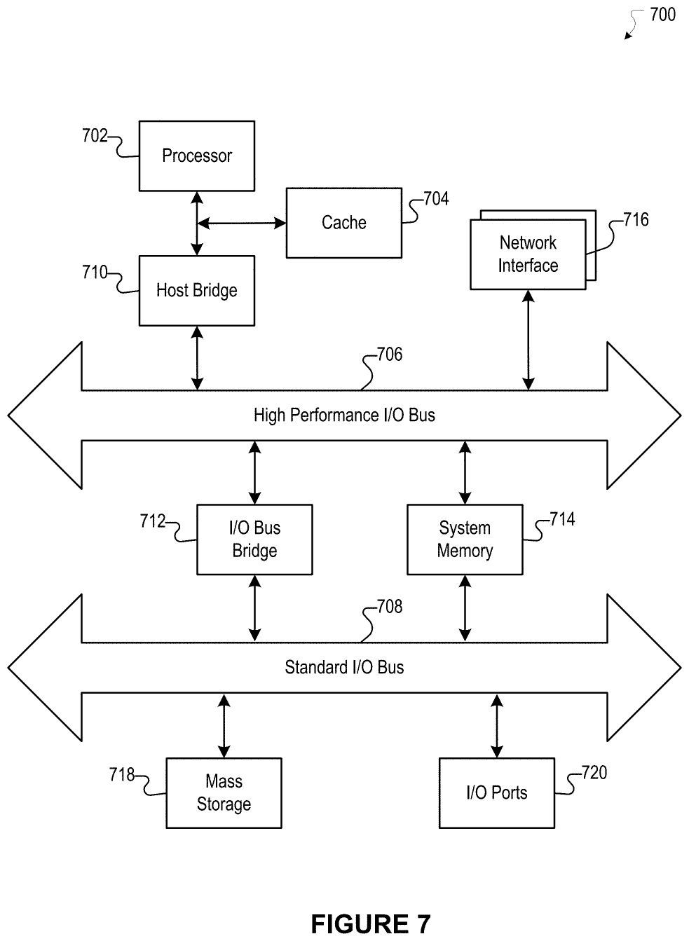

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module,” with processor 702 being referred to as the “processor core.” Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs.” For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the technology can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment,” “an embodiment,” “other embodiments,” “one series of embodiments,” “some embodiments,” “various embodiments,” or the like means that a particular feature, design, structure, or characteristic described in connection with the embodiment is included in at least one embodiment of the technology. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the embodiments of the invention are intended to be illustrative, but not limiting, of the scope of the invention, which is set forth in the following claims.

1. A computer-implemented method comprising:
receiving, by a computing system, a first question associated with an entity, wherein the first question is one of a set of suggested questions that satisfy a threshold frequency and the set of suggested questions is ranked based on availabilities of answers for the suggested questions;
determining, by the computing system, at least one local user based on a location associated with the at least one local user, wherein the at least one local user has been located at the entity within a first threshold amount of time prior to the receiving of the first question by the computing system, and wherein the first threshold amount of time is based on a likelihood of information associated with the first question to change;
providing, by the computing system, the first question to the at least one local user; and
determining, by the computing system, a consensus response to the first question based on responses to the first question received within a second threshold amount of time after the providing the first question, wherein the second threshold amount of time is determined based on a machine learning model and the machine learning model is trained based on timings associated with definitive answers; and
providing, by the computing system, a searchable feature associated with the entity based on the consensus response, wherein the searchable feature allows the entity to be provided as a search result of a search for the searchable feature.

2. The computer-implemented method of claim 1, wherein the set of suggested questions is ranked further based on a frequency associated with each suggested question.

3. The computer-implemented method of claim 1, further comprising:
determining, by the computing system, the first question associated with the entity is inappropriate, inapplicable, or improperly formatted; and
filtering, by the computing system, the first question associated with the entity.

4. The computer-implemented method of claim 1, wherein the first threshold amount of time is further based on a time sensitivity associated with the first question.

5. The computer-implemented method of claim 1, further comprising:
receiving, by the computing system, at least one answer from the at least one local user; and
providing, by the computing system, the at least one answer to a user from whom the first question associated with the entity was received.

6. The computer-implemented method of claim 5, further comprising:
confirming, by the computing system, the location associated with the at least one local user based on the at least one answer.

7. The computer-implemented method of claim 1, wherein the at least one local user is included in a plurality of local users, the method further comprising:
receiving, by the computing system, a plurality of answers from the plurality of local users;
determining, by the computing system, the consensus response based on the plurality of answers; and
providing, by the computing system, the consensus response to a user from whom the question associated with the entity was received.

8. The computer-implemented method of claim 1, wherein the machine learning model is trained further based on timings associated with indefinite answers, and wherein the timings associated with the definitive answers are associated with instances of positive training data and the timings associated with the definitive answers are associated with instances of negative training data.

9. The computer-implemented method of claim 7, further comprising:
extrapolating, by the computing system, a feature or a trend associated with the entity based on the question and the plurality of answers.

10. The computer-implemented method of claim 9, further comprising:
receiving, by the computing system, a second question associated with the entity;
providing, by the computing system, an answer to the second question based on the feature or trend associated with the entity.

11. A system comprising:
at least one processor; and
a memory storing instructions that, when executed by the at least one processor, cause the system to perform:
receiving a first question associated with an entity, wherein the first question is one of a set of suggested questions that satisfy a threshold frequency and the set of suggested questions is ranked based on availabilities of answers for the suggested questions;
determining at least one local user based on a location associated with the at least one local user, wherein the at least one local user has been located at the entity within a first threshold amount of time prior to the receiving of the first question, and wherein the first threshold amount of time is based on a likelihood of information associated with the first question to change;
providing the first question to the at least one local user;
determining a consensus response to the first question based on responses to the first question received within a second threshold amount of time after the providing the first question, wherein the second threshold amount of time is determined based on a machine learning model and the machine learning model is trained based on timings associated with definitive answers; and
providing a searchable feature associated with the entity based on the consensus response, wherein the searchable feature allows the entity to be provided as a search result of a search for the searchable feature.

12. The system of claim 11, wherein the set of suggested questions is ranked further based on a frequency associated with each suggested question.

13. The system of claim 11, further comprising:
determining the first question associated with the entity is inappropriate, inapplicable, or improperly formatted; and
filtering the first question associated with the entity.

14. The system of claim 11, wherein the first threshold amount of time is further based on a time sensitivity associated with the first question.

15. The system of claim 11, further comprising:
receiving at least one answer from the at least one local user; and
providing the at least one answer to a user from whom the first question associated with the entity was received.

16. A non-transitory computer-readable storage medium including instructions that, when executed by at least one processor of a computing system, cause the computing system to perform a method comprising:
receiving a first question associated with an entity, wherein the first question is one of a set of suggested questions that satisfy a threshold frequency and the set of suggested questions is ranked based on availabilities of answers for the suggested questions;
determining at least one local user based on a location associated with the at least one local user, wherein the at least one local user has been located at the entity within a first threshold amount of time prior to the receiving of the first question, and wherein the first threshold amount of time is based on a likelihood of information associated with the first question to change;
providing the first question to the at least one local user;
determining a consensus response to the first question based on responses to the first question received within a second threshold amount of time after the providing the first question, wherein the second threshold amount of time is determined based on a machine learning model and the machine learning model is trained based on timings associated with definitive answers; and
providing a searchable feature associated with the entity based on the consensus response, wherein the searchable feature allows the entity to be provided as a search result of a search for the searchable feature.

17. The non-transitory computer-readable storage medium of claim 16, wherein the set of suggested questions is ranked further based on a frequency associated with each suggested question.

18. The non-transitory computer-readable storage medium of claim 16, further comprising:
determining the first question associated with the entity is inappropriate, inapplicable, or improperly formatted; and
filtering the first question associated with the entity.

19. The non-transitory computer-readable storage medium of claim 16, wherein the first threshold amount of time is further based on a time sensitivity associated with the first question.

20. The non-transitory computer-readable storage medium of claim 16, further comprising:
receiving at least one answer from the at least one local user; and
providing the at least one answer to a user from whom the first question associated with the entity was received.
